(19) United States
(12) Patent Application Publication
(10) Pub. No.: US 2004/0155460 A1
(43) Pub. Date: Aug. 12, 2004

(54) Duct for breeding water in a shower head

(76) Inventor: Fabrizio Nobili, San Vittore (CH)

Correspondence Address: Modiano & Associati, Via Meravigli 16, Milano, 20123, IT

(21) Appl. No.: 10/479,163

(22) PCT Filed: Nov. 21, 2001
(86) PCT No.: PCT/EP01/13526

(30) Foreign Application Priority Data
Jun. 4, 2001 (IT) MN2001A000025

(51) Int. Cl. F16L 27/04

(52) U.S. Cl. 285/261

(57) ABSTRACT

A duct (1) for feeding water in a shower head, the duct being accommodated within an enclosure (2a,2b) and being meant to convey water between an inlet connector (1a) and a dispensing head (1b), the duct comprising, in an intermediate position, an articulated hermetic joint (3) that allows the two sections (4,7) of the duct, located upstream and downstream of the articulated joint, to divaricate with respect to an aligned configuration.

### BACKGROUND OF THE INVENTION

The present invention relates to a duct for feeding water in a shower head.

The configuration of shower heads is known which comprises a duct for feeding water from an inlet connector, suitable to connect by means of a flexible hose to a dispensing head; such duct is contained within an enclosure that is open at one end in order to allow the exit of the connector and has, at its other end, a large opening for the coupling of the head.

### SUMMARY OF THE INVENTION

The enclosure has the purpose of allowing comfortable grip by the user and also has the particularly important purpose of giving the item a high aesthetic value; accordingly, enclosures having the most disparate shapes are commercially available.

Of course, the shape of the water feed duct must be compatible with the shape of the enclosure meant to contain it, and currently a specific duct is manufactured for each enclosure type.

This fact entails high costs for shower head manufacturers, and accordingly the aim of the present invention is to provide a duct for feeding water that can be inserted in enclosures having different shapes.

This aim is achieved by a duct for feeding water in a shower head, according to the invention, said duct being accommodated within an enclosure and being adapted to convey water between an inlet connector and a dispensing head, characterized in that it comprises, in an intermediate position, an articulated joint that allows the two sections of said duct, located upstream and downstream of said articulated joint, to divaricate with respect to an aligned configuration.

### BRIEF DESCRIPTION OF THE DRAWINGS

Further characteristics and advantages of the present invention will become better apparent from the description of a preferred but not exclusive embodiment of the invention, illustrated only by way of non-limitative example in the accompanying drawings, wherein:

FIG. 1 is a side view of a shower head that comprises the duct according to the invention;

FIG. 2 is a perspective view of the shower head of FIG. 1 with the upper housing removed;

FIG. 3 is a perspective exploded view of the shower head;

FIG. 4 is a perspective view of a detail of FIG. 3;

FIGS. 5 and 6 are respectively a side view and a partially sectional view of the duct in the configuration of maximum divarication of the two sections in one direction;

FIGS. 7 and 8 are respectively a side view and a partially sectional view of the duct in the configuration of maximum divarication of the two sections in the opposite direction with respect to FIGS. 5 and 6.

### DESCRIPTION OF THE PREFERRED EMBODIMENTS

With reference to the figures, the reference numeral 1 generally designates a duct contained within an enclosure formed by a lower portion 2a and an upper portion 2b in order to feed water from an inlet connector 1a to a dispensing head 1b.

The duct 1 comprises, in an intermediate position, an articulated joint, generally designated by the reference numeral 3, that is described in detail hereafter and is suitable to allow divarications other than the aligned configuration of the resulting two sections located upstream and downstream of the articulated joint: a section 4, which comprises the inlet connector 1a and is fixed to the lower portion 2a of the enclosure by way of screws 5a and 5b inserted in holes provided in a plate 6 that is monolithically connected to section 4, and a section 7, which comprises a hood 7a for conveying water to the dispensing head 1b, which is fixed to the lower portion 2a by way of screws 8a and 8b inserted in the holes provided respectively in brackets 9a and 9b connected monolithically to section 7.

The articulated joint 3 is now described in detail.

The articulated joint 3 comprises hemispherical tip 10, which is rotatably inserted at its shank 10a in a seat 7b provided at the end of the section 7 that is directed toward the articulated joint, and the section 4 has, at its end 4a, which in turn is directed toward the articulated joint, a surface that is complementary to the hemispherical tip 10 and allows to accommodate a sealing gasket 11.

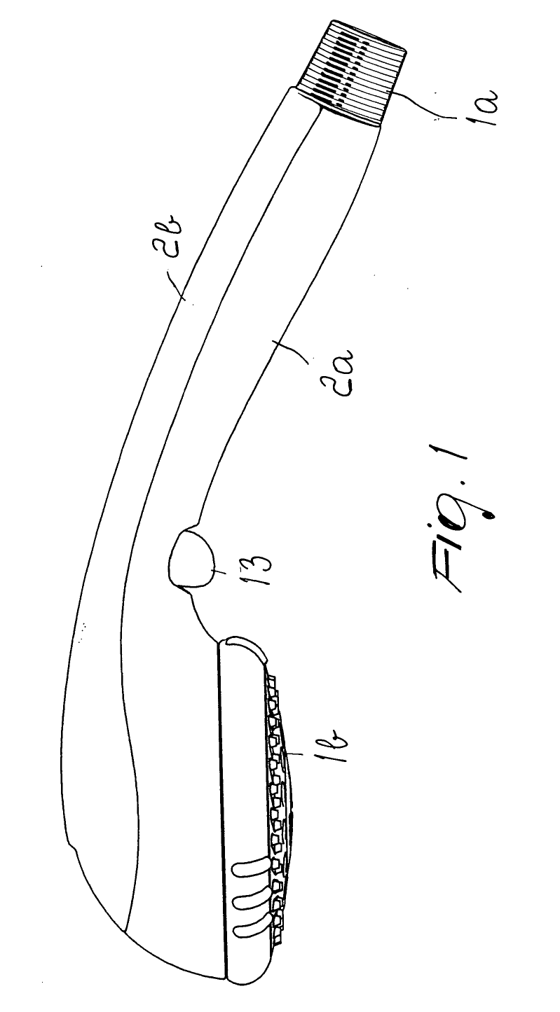

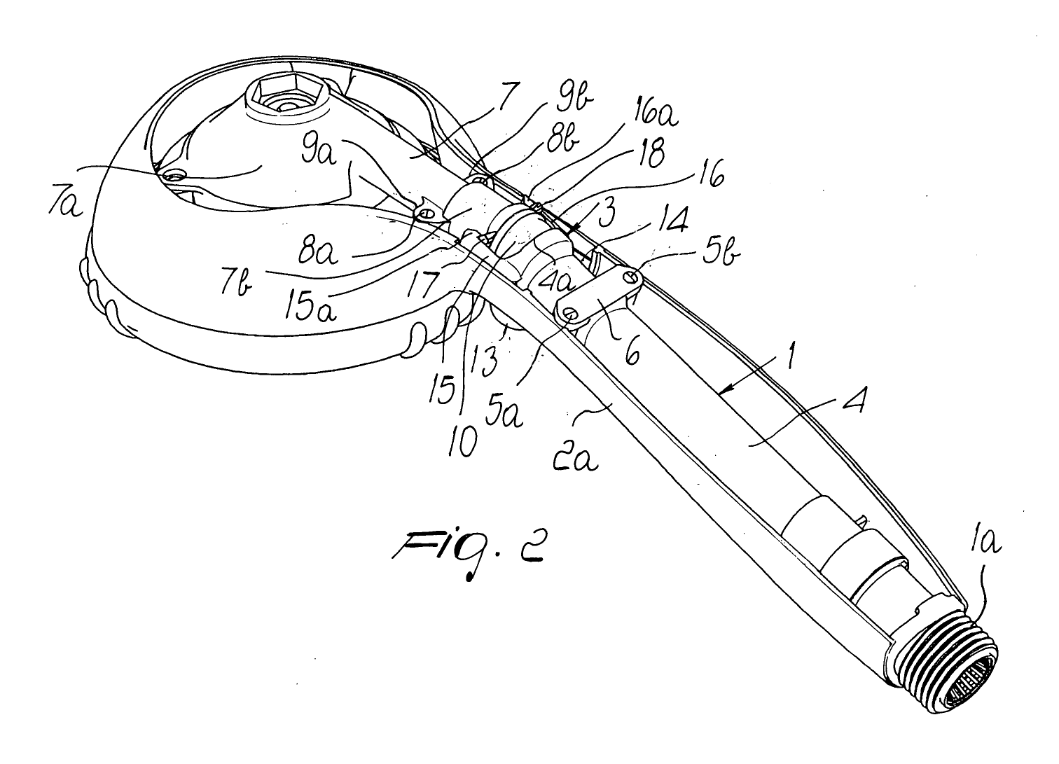

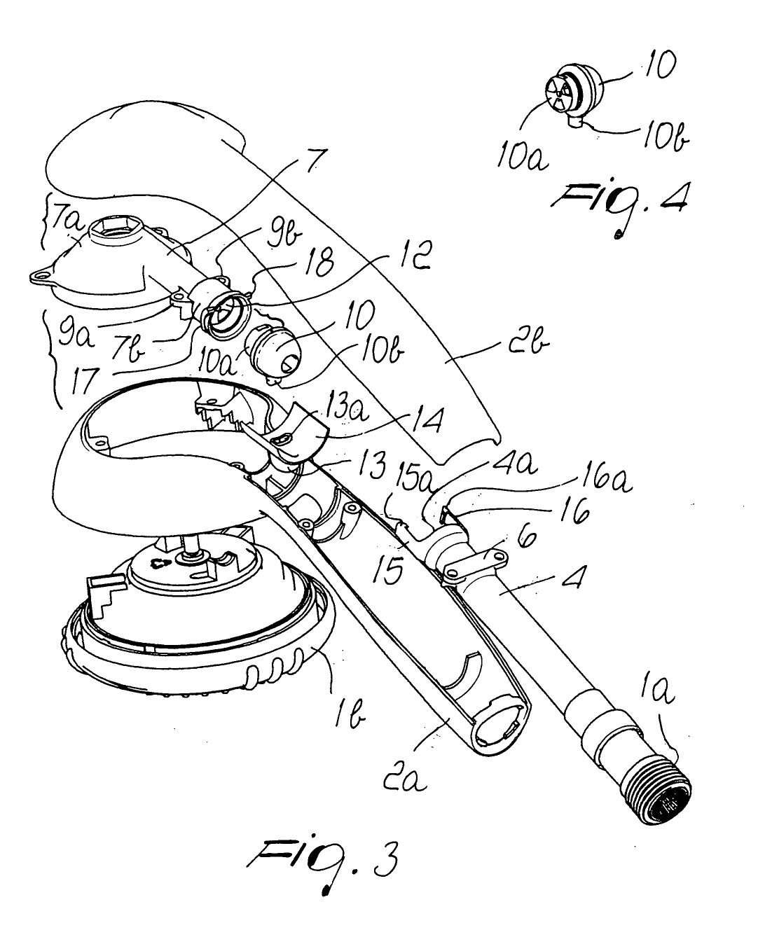

The hemispherical tip 10, with its shank 10a, is shaped like the movable element of a flow-rate limiter, known per se and therefore not described in detail, in which a fixed tube-shaped element 12 is inserted in the seat 7b; in order to allow the actuation of the device by a user, the tip 10 is provided with a lug 10b, which is suitable to enter, by passing through an opening 13a defined in a cradle 14, a lever 13 that protrudes from the cradle 14 rested on the lower portion 2a of the enclosure in order to exit from said portion, as clearly shown in FIG. 1, so that it can be actuated by the user.

The articulated joint 3 is provided with means for the mutual engagement of the two sections 4 and 7 of the duct, which comprise two lugs 15 and 16 that protrude from the section 4 and are provided with teeth 15a and 16a, which are suitable to mate with a snap action, thanks to the elasticity of the lugs, respectively with guides 17 and 18 that protrude from the section 7 and are provided identically with a circular shape centered on the rotation axis of the articulated joint.

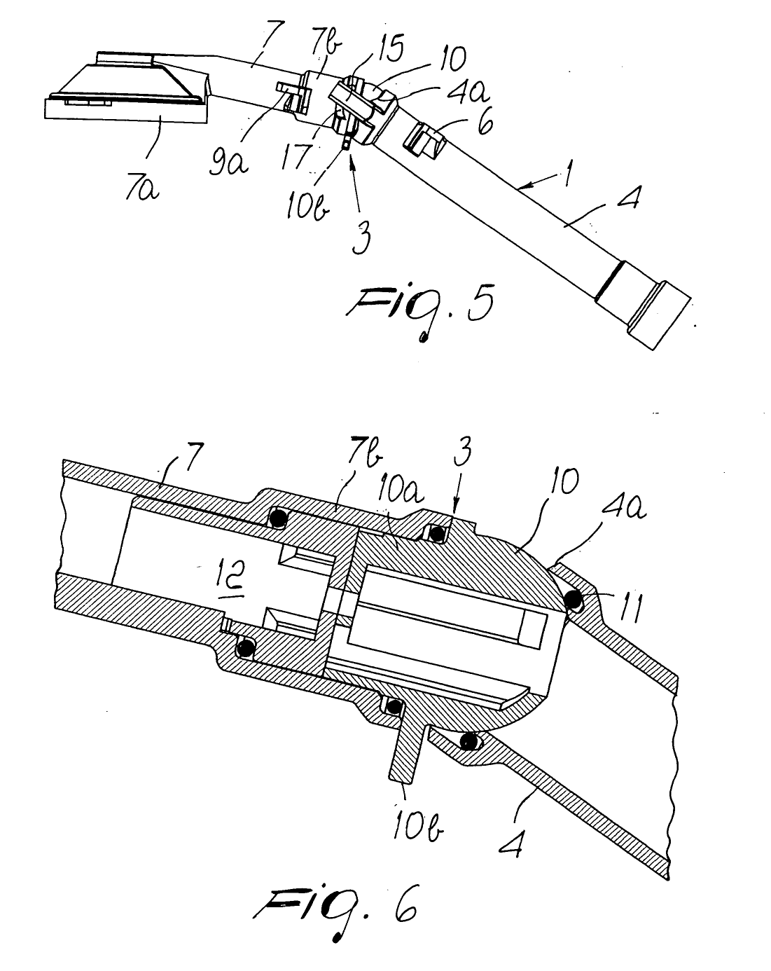

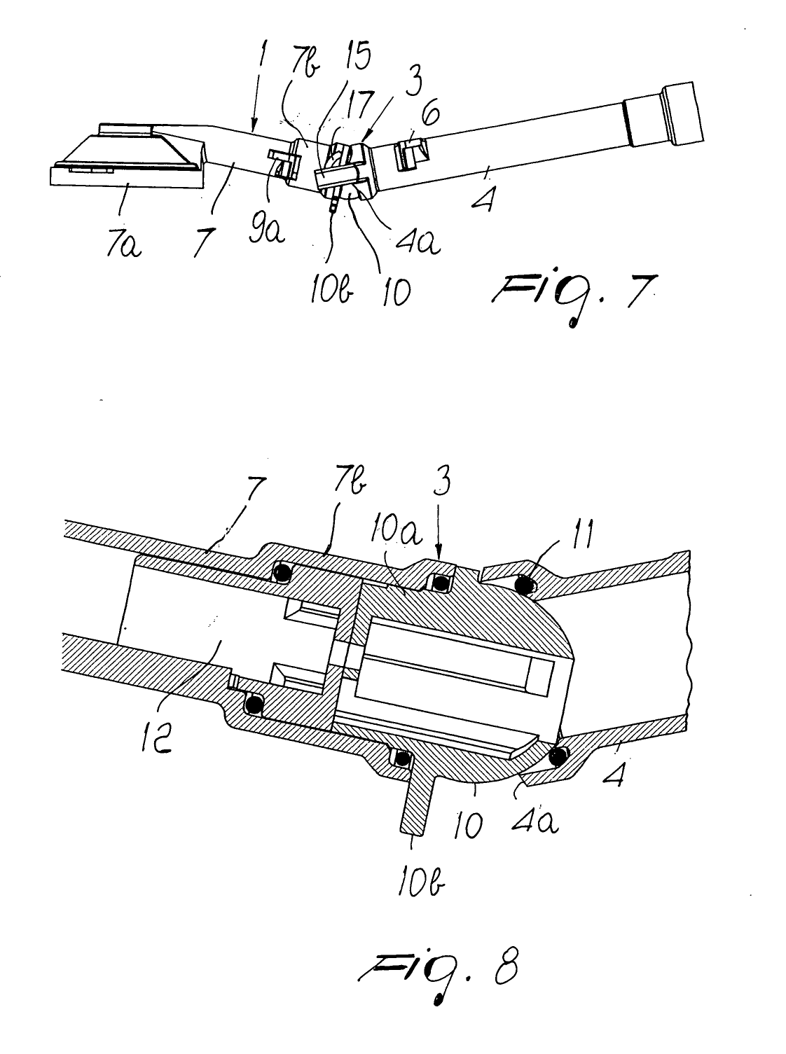

The presence of the articulated joint 3 shaped as described thus allows the duct 1 to assume configurations with different divarications (i.e. different angles one with respect to another) of the two sections 4 and 7 with respect to each other between the two extreme conditions shown respectively in FIGS. 5 and 7, and this fact clearly allows to adapt the duct 1 according to the invention to a very wide range of enclosure shapes.

The described invention is susceptible of numerous modifications and variations, all of which are within the scope of the inventive concept; thus, for example, the articulated joint 3 can be provided in any shape, and in particular a hemispherical tip can be monolithically associated with the end of one of the sections duct, excluding the presence of the flow-rate limiter.

The requirement of having a perfectly hermetic articulated joint 3 is of course always maintained.

The disclosures in Italian Patent Application No. MN2001A000025 from which this application claims priority are incorporated herein by reference.

1. A duct (1) for feeding water in a shower head, said duct being accommodated within an enclosure (2a,2b) and being adapted to convey water between an inlet connector (1a) and a dispensing head (1b), characterized in that it comprises, in an intermediate position, an articulated joint (3) that allows the two sections (4,7) of said duct, located upstream and downstream of said articulated joint, to divaricate with respect to an aligned configuration.

2. The duct according to claim 1, characterized in that it comprises independent means (5a,5b,8a,8b) for fixing the two sections (4,7) to the enclosure (2a,2b).

3. The duct according to one or more of the preceding claims, characterized in that the ends of the two sections that converge at the articulated joint respectively have a hemispherical tip (10) and a shape that is complementary with respect to said tip, means (15,16,17,18) for the mutual engagement of the two sections (4,7) being provided.

4. The duct according to one or more of the preceding claims, characterized in that the end surface of a section that is complementary with respect to the hemispherical tip (10) provided at the end of the other section has a shape that is suitable to accommodate a sealing gasket (11).

5. The duct according to one or more of the preceding claims, characterized in that the means for the mutual engagement of the two sections comprise at least two lugs (15,16) that protrude from one section (4) and are provided with an end tooth (15a,16a) that is suitable to mate with a snap action with a guide (17,18) which is located on the other section (7) and has a circular shape centered on the rotation axis of the articulated joint (3).

6. The duct according to one or more of the preceding claims, characterized in that the hemispherical tip (10) is monolithically associated with the end of one section of the duct.

7. The duct according to one or more of the preceding claims, characterized in that the hemispherical tip (10) is rotatably associated with the end of a section of the duct and is shaped like the movable element of a flow-rate limiter, the fixed element of said device being associated inside said section.

8. The duct according to one or more of the preceding claims, characterized in that the hemispherical tip (10) rotatably associated with the end of a section of the duct is provided with a lug (10b) that is suitable to enter a lever (13) that protrudes from a cradle (14) rested on the lower portion of the enclosure (2) in order to protrude from said enclosure so that it can be actuated by a user.
